(19) United States
(12) Patent Application Publication
(10) Pub. No.: US 2005/0115105 A1
(43) Pub. Date: Jun. 2, 2005

(54) Home appliance assembly and method of manufacturing the same

(76) Inventors: Jeung Gie Ahn, Seoul (KR); Sung Gi Hwang, Changwon-si (KR); Jung Woo Seo, Changwon-si (KR)

Correspondence Address: MCKENNA LONG & ALDRIDGE LLP, 1900 K STREET, NW, WASHINGTON, DC, 20006, US

(21) Appl. No.: 10/995,120

(22) Filed: Nov. 24, 2004

(30) Foreign Application Priority Data
Nov. 28, 2003 (KR) P 2003-85615
Nov. 28, 2003 (KR) P 2003-85617
Nov. 28, 2003 (KR) P 2003-85618

(51) Int. Cl. F26B 11/02; F26B 5/06

(52) U.S. Cl. 34/603; 34/282

(57) ABSTRACT

A home appliance assembly and method of manufacturing the same employs a coupling plate facilitating the assembly of a home appliance, such as a laundry dryer, having a structurally sound outer case. The home appliance assembly includes at least two panels forming adjacent faces of an outer case; a coupling plate, coupled to each panel, for reinforcing a structural strength of the outer case; and, for aligning the coupling plate with respect to at least one of the two panels, a pair of opposing stops for capturing the coupling plate or at least one alignment finger for insertion into corresponding finger holes. A method for manufacturing a home appliance assembly includes joining the coupling plate with a first panel of the at least two adjacent panels, to form a subassembly having an exterior surface, the subassembly being separately processed from a second panel of the at least two adjacent panels; applying an enamel coating to the exterior surface of the subassembly; and coupling the enamel-coated subassembly to the second panel.

This application claims the benefit of Korean Applications No. 10-2003-0085615, No. 10-2003-0085617, and No. 10-2003-0085618, each filed on Nov. 28, 2003, which are hereby incorporated by reference.

### BACKGROUND OF THE INVENTION

1. Field of the Invention

The present invention relates to home appliances, and more particularly, to a home appliance assembly and method of manufacturing the same, which employs a coupling plate facilitating the assembly of a home appliance, such as a laundry dryer, having a structurally sound outer case.

2. Discussion of the Related Art

A home appliance generally comprises a plurality of outer panels forming an outer case for housing the inner workings of the appliance, with each panel essentially constituting one face of the outer case. For logistical and aesthetic reasons, the outer panels are typically provided as components made of sheet metal to be structurally joined at the edges and are typically coated with vitreous enamel to resist corrosion and enhance appearance. In joining these panels to form the outer case of a home appliance, structural strength and integrity and ease of assembly should be considered.

As an exemplary home appliance, FIG. 1 illustrates a contemporary laundry dryer in which an outer case 100 includes a top panel 50 to be assembled to a back cover (not shown in FIG. 1) of the laundry dryer. The outer case 100 further includes a base 10 forming the bottom of the laundry dryer, to which a front panel 20 and a pair of side panels 30 are assembled. It should be appreciated that, for installing an appliance in a home (typically, against a wall), the appliance should be afforded a service space S between the back cover and the wall, which is achieved by extending at least one panel beyond a rear surface of the back cover.

FIG. 2 illustrates a coupling structure of a home appliance assembly according to a conventional art, showing the top panel 50 and back cover 40 of the laundry dryer of FIG. 1. Here, a mounting rail 40a protrudes from an upper rear surface of the back cover 40 to provide a mounting surface for coupling with the top panel 50 along an inner edge of a top panel extension 52. The top panel 50 is provided with a pair of flanges 50a extending downward from a lower edge of the top. panel extension 52, and a first coupling hole 51 is formed in each flange, to be aligned with a second coupling hole 41 provided at either end of the mounting rail 40a. Meanwhile, a sheet metal coating process is performed on the top panel 50, to cover its exterior surface with vitreous enamel, and typically excludes the back cover 40.

To couple the top panel 50 and back cover 40, the first coupling holes 51 are aligned with the second coupling holes 41 to allow a manual insertion of a threaded coupling means, such as screws or bolts, to be tightened against coated surface of at least the flanges 50a of the top panel 50. Therefore, since the vitreous enamel is weaker than the sheet metal forming the top panel 50, the necessary tightening of the coupling means tends to crack the vitreous enamel, and, over time, the cracking allows the top panel to corrode. Meanwhile, excessive tightening of the coupling means may distort the mounting rail 40a in addition to the cracking.

Moreover, alignment of the coupling holes during assembly is time consuming and cumbersome, requiring more than one worker and loose assembly tolerances. Even after such assembly, however, the strength provided by the coupling structure of the conventional art is poor.

### SUMMARY OF THE INVENTION

Accordingly, the present invention is directed to a home appliance assembly that substantially obviates one or more problems due to limitations and disadvantages of the related art.

An object of the present invention, which has been devised to solve the foregoing problems, lies in providing a home appliance assembly having an outer case exhibiting high structural strength.

Another object of the present invention is to provide a home appliance assembly which facilitates assembly of the outer case.

Another object of the present invention is to provide a home appliance assembly which preserves the corrosion resistant properties of a vitreous enamel coating applied to the outer case.

Another object of the present invention is to provide a home appliance assembly which preserves the appearance of the outer case.

Another object of the present invention is to provide a home appliance assembly which prevents a distortion of the outer case when assembling the top panel and rear cover.

Another object of the present invention is to provide a method of manufacturing any one of the above home appliance assemblies.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages in accordance with the purpose of the invention as embodied and broadly described herein, there is provided a home appliance assembly comprising at least two panels forming adjacent faces of an outer case; a coupling plate, coupled to each of the at least two adjacent panels, for reinforcing a structural strength of the outer case; and self-alignment means for aligning the coupling plate with respect to at least one of the at least two adjacent panels.

The home appliance of the present invention is embodied as a laundry dryer comprising a top panel forming a top face of an outer case; a back cover forming a rear face of the outer case; a coupling plate having a main support for reinforcing a structural strength of the outer case, the coupling plate having a first mounting flange coupled with the top panel and a second mounting flange coupled with the back cover, the first and second mounting flanges integrally formed with opposite edges of the main support; and a self-alignment means. According to a first embodiment, the self-alignment means includes a pair of opposing stops, respectively provided to opposite sides of one of the top panel and back cover, for capturing the coupling plate and thereby horizontally aligning the coupling plate with respect to at least one of the top panel and back cover. According to a second embodiment, the self-alignment means includes at least one alignment finger provided to the coupling plate to oppose at least one finger hole, the finger holes being correspondingly formed in the top panel to receive the at least one alignment finger and thereby horizontally align the coupling plate with respect to at least one of the top panel and back cover.

According to another aspect of the present invention, there is provided a method for manufacturing a home appliance assembly including an outer case comprising at least two panels forming adjacent faces of an outer case and a coupling plate for reinforcing a structural strength of the outer case. The method comprises joining the coupling plate with a first panel of the at least two adjacent panels, to form a subassembly having an exterior surface, the subassembly being separately processed from a second panel of the at least two adjacent panels; applying an enamel coating to the exterior surface of the subassembly; and coupling the enamel-coated subassembly to the second panel.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of an outer case of a contemporary laundry dryer;

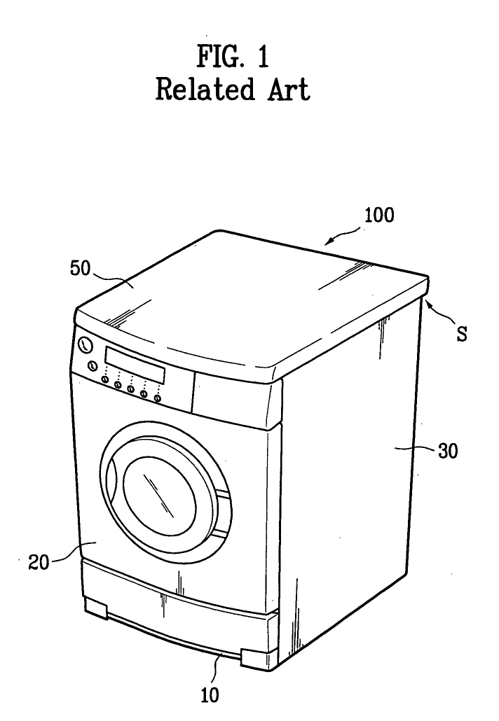

FIG. 2 is a perspective rear view of an assembly structure of the laundry dryer of FIG. 1;

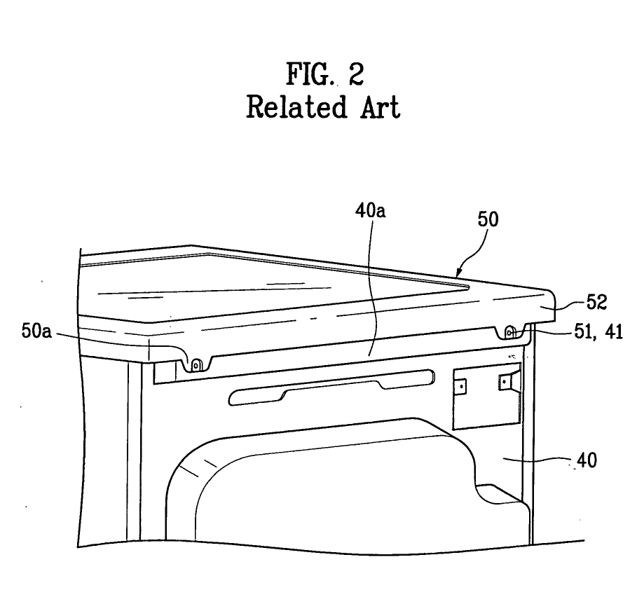

FIG. 3 is an exploded perspective rear view of an assembly structure of a home appliance according to a first embodiment of the present invention;

FIG. 4 is an exploded perspective rear view of an assembly structure of a home appliance according to a second embodiment of the present invention;

FIG. 5 is a reverse perspective view of the coupling plate shown in FIG. 4; and

FIG. 6 is a perspective view of the outer case of a home appliance adopting the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The present invention may be applied to any home appliance having joined panels forming an outer case. In the accompanying drawings, a drum-type laundry dryer is shown for illustrative purposes only.

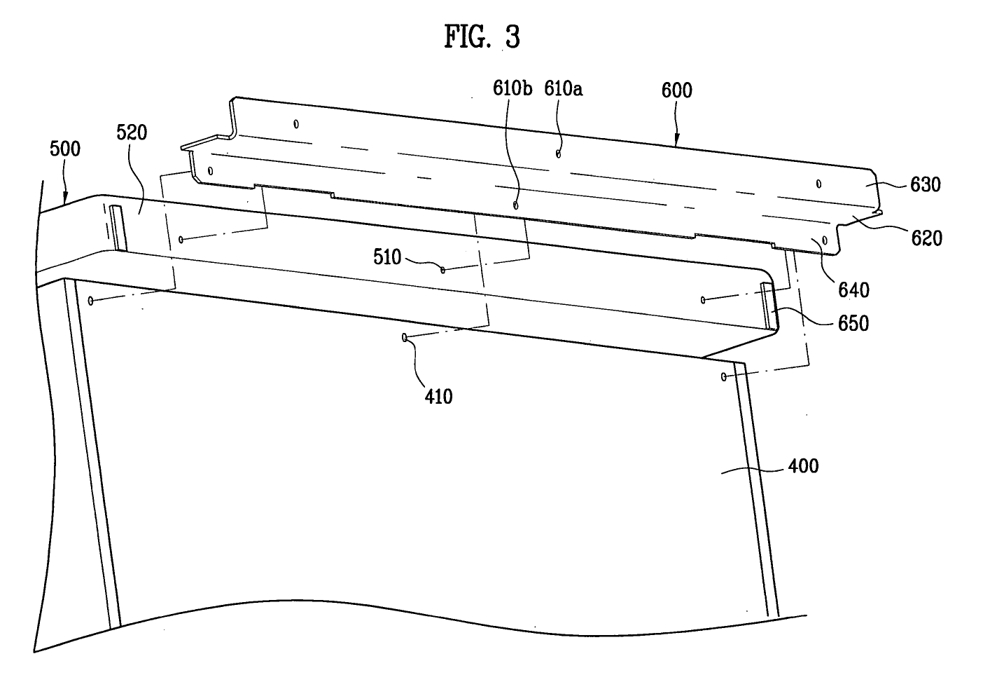

Referring to FIG. 3, illustrating an assembly structure of a home appliance having an outer case according to a first embodiment of the present invention, a back cover 400 forms a rear face of the outer case. A top panel 500, forming a top face of the outer case, has a top panel extension 520 that protrudes a predetermined distance beyond a rear surface of the back cover and creates a service space. Although not shown in the drawings, the back cover 400 may be disposed more rearwardly than a rear surface of the top panel extension 520. In any event, the rearward-facing surfaces of the top panel extension 520 and the back cover 400 occupy different planes, creating a surface offset for enhancing structural strength.

The above assembly structure includes a coupling plate 600 for coupling two adjacent panels forming respective faces of the outer case of the home appliance according to the present invention. In the preferred embodiment, the adjacent components are the top panel 500 and back cover 400. The coupling plate 600, which has a cross-section corresponding to the profile of the upper rear side of the outer case, reinforces the strength of the coupling of the top panel 500 and the back cover 400, while facilitating assembly of the outer case using a threaded coupling means such as a plurality of screws or bolts. The coupling is achieved by manipulating the coupling means via a plurality of coupling holes respectively formed in the top panel 500, the back cover 400, and the coupling plate 600, which are aligned during assembly using a self-alignment means (described later).

The top panel 500 has a plurality of first coupling holes 510 formed at predetermined locations in the top panel extension 520, the back cover 400 has a plurality of second coupling holes 410 similarly formed, and the coupling plate 600 has pluralities of third and fourth coupling holes 610a and 610b, which are through holes corresponding to the first and second coupling holes, respectively. The coupling holes 510 and 410 may be provided as pilot holes or captured nuts for receiving the threads of the coupling means.

The coupling plate 600 is formed by bending a metal plate of a predetermined strength into a substantially tri-planer shape having smooth surfaces and rounded edges to promote a hospitable environment for a user. The coupling plate 600 includes a main support 620, having a width corresponding to that of the top panel extension 520, and first and second mounting flanges 630 and 640 respectively extending at opposing right angles from opposite edges of the main support, to impart the coupling plate with structural strength. Thus, the coupling plate 600 is shaped so that, when assembled, the first mounting flange 630 abuts the rear surface of the top panel extension 520 of the top panel 500 and the second mounting flange 430 abuts the upper rear surface of the back cover 400, thereby aligning the third and fourth coupling holes 610a and 610b with the first and second coupling holes 510 and 410, respectively. The assembly elements of the outer case are aligned as above so that the coupling means may be inserted and tightened. In doing so, the top panel 500 and back cover 400, i.e., the two adjacent panels of the outer case of the home appliance assembly of the present invention, are assembled by fixing the coupling plate 600 to each panel.

To enhance the appearance of the assembled outer case, the first mounting flange 630 is preferably shorter than a lateral width of the top panel 500, specifically, the lateral width of the top panel extension 520, while the length of the main support 620 is roughly equal to the top panel's lateral width. The material of the coupling plate 600 is preferably a metal having a lower strength than that of the top panel 500, to prevent a cracking of the vitreous enamel coating the top panel around the first coupling holes 510, which may occur when applying a tightening force to the coupling means to secure the coupling plate to the top panel. If the coupling plate 600 were weaker than the top panel 500, the applied tightening force would be transferred to the top panel at the first coupling holes 510, increasing the tendency for cracking. Since the coupling plate 600 is frequently exposed to moisture, particularly for home appliances such as dishwashers, washing machines, and laundry dryers, the coupling plate is preferably made of stainless steel.

Furthermore, though not specifically shown in the drawings, the material of the first and second mounting flanges 630 and 640 may be minimized, to reduce the weight and cost of the coupling plate 600, by minimally forming one or both flanges to provide each corresponding coupling hole with an individual flange. Thus, each mounting flange 630 and 640 may comprise a plurality of individual flanges, corresponding to the third and fourth coupling holes 610a and 610b and respectively extending from separate locations along the edges of the main support 620, to surround each coupling hole with a minimum of material for establishing a mounting surface adjacent the hole.

According to the present invention, the coupling plate 600 is aligned with respect to each of the top panel 500 and the back cover 400, using a self-alignment means for achieving both vertical and horizontal alignment by installing the coupling plate with respect to the outer case during assembly.

Vertical alignment of the coupling holes is achieved by abutting the main support 620 against a lower surface of the top panel extension 520. In the case of disposing the back cover 400 more rearwardly than the rear surface of the top panel extension 520, the vertical alignment of the coupling holes is achieved by abutting the main support 620 against an upper surface (not shown) created by the surface offset between the reward-facing surfaces of the top panel extension and the back cover.

According to a preferred embodiment, horizontal alignment of the coupling holes can be achieved by loading the coupling plate 600 between a pair of opposing stops 650 respectively provided on the top panel 500. Specifically, the first mounting flange 630 is captured between the opposing stops 650, which are positioned at opposite ends of the top panel extension 520 to protrude from its rear surface and thereby enable a self-alignment of the coupling plate 600. As an alternative, the opposing stops 650 may be provided on opposite sides of the upper rear surface of the rear cover 400, to receive the second mounting flange 640 between the opposingly positioned stops. In either case, the opposing stops 650 may be integrally formed with the top panel 500 or back cover 400 or may be subsequently affixed to its surface. If integrally formed, the top panel 500 or back cover 400 may be recessed to receive the mounting flange 630 or 640 of the coupling plate 600, so that opposing inner ends of the recess serve as the opposing stops 650.

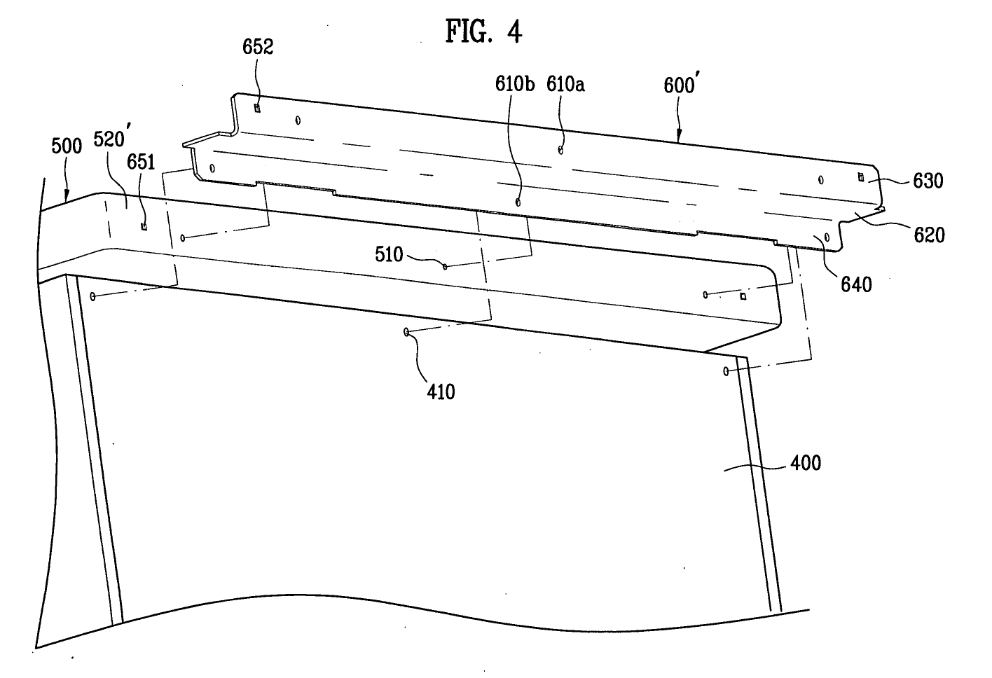

FIG. 4 illustrates an assembly structure of a home appliance according to a second embodiment of the present invention, in which horizontal alignment is achieved by alternative means. Here, a coupling plate 600′ includes at least one alignment finger 652 for achieving horizontal alignment by inserting the finger(s) into at least one finger hole 651 formed in a top panel extension 520′. Preferably, there is a finger hole 651 formed at each end of the top panel extension 520′ for respectively receiving a pair of correspondingly provided alignment fingers 652 protruding inwardly from the first mounting flange 630. The finger holes may be alternatively or additionally formed in the back cover 400 for receiving alignment fingers provided to the second mounting flange 640, or the finger holes may be formed in at least one of the mounting flanges of the coupling plate for receiving alignment fingers correspondingly provided on the top panel extension and/or back cover. In any event, when the alignment fingers 652 are inserted into the finger holes 651, the coupling plate 600′ is provisionally fixed to the rear surface of the outer case of the home appliance, to align the third coupling holes 610a with the first coupling holes 510 and align the fourth coupling holes 610b with the second coupling holes 410 and thereby allow insertion and tightening of the coupling means.

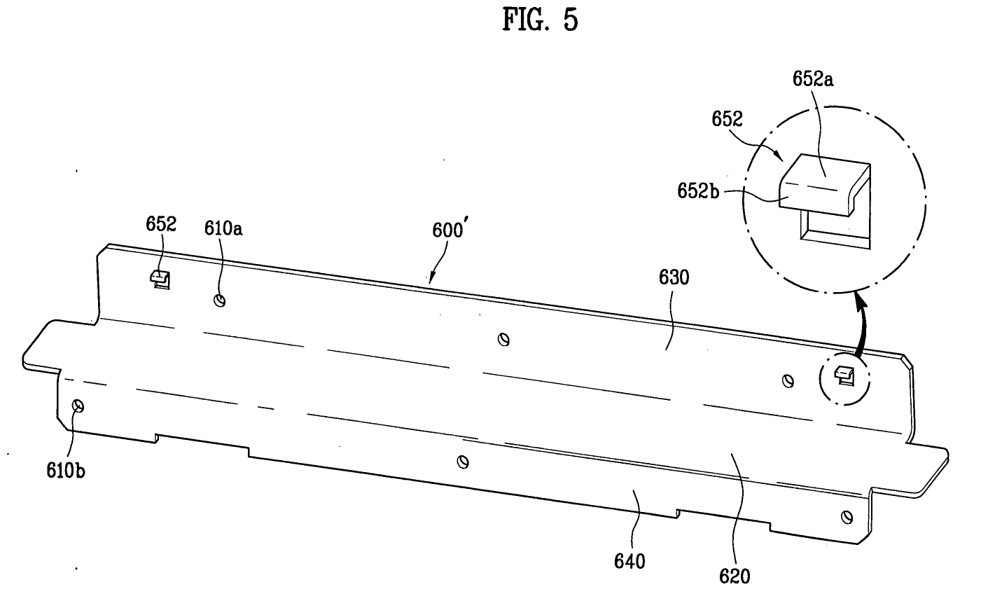

As shown in FIG. 5, the alignment finger 652 preferably has an L-shaped cross-section formed by a hook 652b extending downward from the distal end of an arm 652a integrally formed with the coupling plate 600′ by a lancing process. The inner surface of the hook 652b is separated from the inner surface of the coupling plate 600′ by a predetermined distance corresponding to a panel thickness of the top panel extension 520′, allowing the alignment finger 652 to engage firmly with the finger hole 651 when the alignment finger is inserted into and caught by the finger hole so that the coupling plate is seated by being dropped into place.

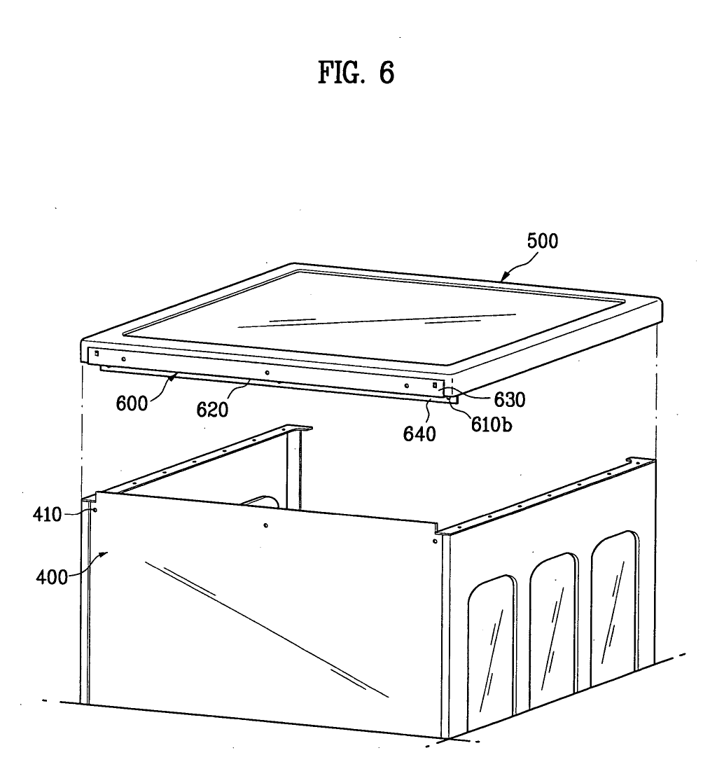

In manufacturing the above-described outer case of a home appliance assembly according to the presenting invention, the top panel 500 (a first panel) and back cover 400 (a second panel) are adjacent panels to be coupled while a hole alignment is performed using the coupling plate 600, which is self-aligned according to the first or second embodiments. In doing so, the coupling plate 600 (or 600′) is first joined to one of the two adjacent panels to produce a subassembly to be subsequently coupled to the other adjacent panel by installing coupling means such as screws or bolts. Thus, the subassembly includes the coupling plate 600 (or 600′) and the top panel 500 as shown in FIG. 6, or a subassembly (not shown) of the coupling plate and back cover 400, and the subassembly is coated with vitreous enamel before installing the coupling means to the other adjacent panel, thereby minimizing the chances for generating cracks in the vitreous enamel when tightening the coupling means. As an alternative to a universal use of the above-described coupling means, the coupling plate 600 (or 600′) may be joined to the adjacent panel (e.g., the top panel 500) using a plurality of spot welds, rivets, or Tox round joints corresponding to the first and third coupling holes 510 and 610a or the second and fourth coupling holes 410 and 610b .

The above-described assembly structure of a home appliance adopting the present invention enhances the structural strength of an outer case of the home appliance, since the coupling plate disposed at the rear of the outer case has a profile corresponding to the surface offset created by rearward-facing surfaces of the top panel extension and the back cover. Damage to the vitreous enamel during coupling can be prevented by forming the coupling plate of a metal having a lower strength than that of the top panel and can be minimized by performing the vitreous enamel coating process to a subassembly produced by first joining the coupling plate to one of the top panel and back cover, i.e., before installing and tightening screws or bolts, which also reduces assembly time by eliminating a separate coating step for the coupling plate. The coupling holes are self-aligned horizontally by inserting a pair of alignment fingers into corresponding finger holes to produce a provisional assembly of the coupling plate and a panel (face) of the outer case or by providing a panel with a pair of opposing stops for receiving a mounting flange of the coupling plate.

It will be apparent to those skilled in the art that various modifications and variations can be made in the present invention. Thus, it is intended that the present invention cover the modifications and variations of this invention provided they come within the scope of the appended claims and their equivalents.

1. A home appliance assembly comprising:
at least two panels forming adjacent faces of an outer case;
a coupling plate, coupled to each of said at least two adjacent panels, for reinforcing a structural strength of the outer case; and
self-alignment means for aligning said coupling plate with respect to at least one of said at least two adjacent panels.

2. The home appliance assembly as claimed in claim 1, wherein the first and second panels occupy disparate planes creating a surface offset between the first and second panels.

3. The home appliance assembly as claimed in claim 2, wherein said coupling plate has a cross-section corresponding to a profile created by the surface offset between the first and second panels.

4. The home appliance assembly as claimed in claim 1, wherein the first panel has a rear surface disposed rearward of said second panel.

5. The home appliance assembly as claimed in claim 1, wherein the second panel has a rear surface disposed rearward of the first panel.

6. The home appliance assembly as claimed in claim 1, wherein said coupling plate comprises:
a main support;
a first mounting flange, integrally formed with a first edge of said main support, for coupling with a first panel of said at least two adjacent panels; and
a second mounting flange, integrally formed with a second edge of said main support, for coupling with a second panel of said at least two adjacent panels.

7. The home appliance assembly as claimed in claim 6, wherein at least one of said first and second mounting flanges comprises a plurality of individual flanges, corresponding to a plurality of coupling holes formed in the at least one of said first and second mounting flanges, to surround each coupling hole separately and establish respective mounting surfaces.

8. The home appliance assembly as claimed in claim 6, wherein said main support has a length equal to a lateral width of the first panel.

9. The home appliance assembly as claimed in claim 6, wherein at least one of said first and second mounting flanges is shorter than a lateral width of the first and second panels.

10. The home appliance assembly as claimed in claim 6, wherein said first and second mounting flanges extend in opposite directions at right angles with respect to said main support.

11. The home appliance assembly as claimed in claim 6, wherein said self-alignment means achieves a vertical alignment of said coupling plate with respect to at least. one of said at least two adjacent panels, by abutting said main support against a horizontal surface created by offsetting rear surfaces of the first and second panels.

12. The home appliance assembly as claimed in claim 1, wherein said self-alignment means comprises:
a pair of opposing stops, respectively provided to opposite sides of at least one of said at least two adjacent panels, for capturing said coupling plate and thereby horizontally aligning said coupling plate with respect to said at least two adjacent panels.

13. The home appliance assembly as claimed in claim 12, wherein said pair of opposing stops is formed by recessing the at least one of said at least two adjacent panels.

14. The home appliance assembly as claimed in claim 12, wherein said pair of opposing stops is formed by affixing the opposing stops respectively to opposite sides of the at least one of said at least two adjacent panels.

15. The home appliance assembly as claimed in claim 1, wherein said self-alignment means comprises:
at least one alignment finger provided to said coupling plate to oppose at least one finger hole, the finger holes being correspondingly formed in at least one of said two adjacent panels to receive said at least one alignment finger and thereby horizontally align said coupling plate with respect to said at least two adjacent panels.

16. The home appliance assembly as claimed in claim 15, wherein said at least one alignment finger is formed by a lancing process.

17. The home appliance assembly as claimed in claim 15, wherein said at least one alignment finger comprises:
an arm, integrally formed with said coupling plate, to protrude from an inner surface of said coupling plate toward said at least two adjacent panels; and
a hook, extending downward from a distal end of said arm, to engage firmly with the corresponding finger hole.

18. The home appliance assembly as claimed in claim 17, wherein said hook has an inner surface separated from the inner surface of said coupling plate by a distance corresponding to a thickness of one of the first and second panels.

19. The home appliance assembly as claimed in claim 15, wherein said at least one alignment finger has an L-shaped cross-section.

20. The home appliance assembly as claimed in claim 1, wherein said self-alignment means comprises:
at least one alignment finger provided to at least one of said two adjacent panels to oppose at least one finger hole, the finger holes being correspondingly formed in said coupling plate to receive said at least one alignment finger and thereby horizontally align said coupling plate with respect to said at least two adjacent panels.

21. The home appliance assembly as claimed in claim 1, wherein said at least two adjacent panels include first and second panels, the first panel having a rear surface in which a plurality of first coupling holes are formed and the second panel having a rear surface in which a plurality of second coupling holes are formed, and wherein said coupling plate includes a first mounting flange in which a plurality of third coupling holes are formed and a second mounting flange in which a plurality of fourth coupling holes are formed.

22. The home appliance as assembly claimed in claim 21, wherein, when said alignment finger is inserted into the finger hole, the plurality of third coupling holes of said coupling plate aligns horizontally with respect to the plurality of first coupling holes of the first panel and the plurality of fourth coupling holes of said coupling plate aligns horizontally with respect to the plurality of second coupling holes of the second panel.

23. The home appliance as assembly claimed in claim 21, wherein, when said main support is abutted against a horizontal surface created by offsetting rear surfaces of the first and second panels, the plurality of third coupling holes of said coupling plate align vertically with respect to the plurality of first coupling holes of the first panel and the plurality of fourth coupling holes of said coupling plate align vertically with respect to the plurality of second coupling holes of the second panel.

24. The home appliance assembly as claimed in claim 1, wherein said coupling plate is coupled to a first panel of said at least two adjacent panels, using a coupling means passing through at least one third coupling hole formed in said coupling plate to be received by at least one first coupling hole formed in the first panel.

25. The home appliance assembly as claimed in claim 1, wherein said coupling plate is coupled to a second panel of said at least two adjacent panels, using a coupling means passing through at least one fourth coupling hole formed in said coupling plate to be received by at least one second coupling hole formed in the second panel.

26. The home appliance assembly as claimed in claim 1, wherein said coupling plate is made of stainless steel.

27. The home appliance assembly as claimed in claim 1, wherein said coupling plate is made of a metal having a lower strength than the first and second panels.

28. The home appliance assembly as claimed in claim 1, wherein said at least two adjacent panels includes a top panel forming a top face of the outer case and a back cover forming a rear face of the outer case.

29. The home appliance assembly as claimed in claim 1, wherein the home appliance assembly is a laundry dryer.

30. A laundry dryer comprising:
a top panel forming a top face of an outer case;
a back cover forming a rear face of the outer case;
a coupling plate having a main support for reinforcing a structural strength of the outer case, said coupling plate having a first mounting flange coupled with said top panel and a second mounting flange coupled with said back cover, the first and second mounting flanges integrally formed with opposite edges of the main support; and
self-alignment means including a pair of opposing stops, respectively provided to opposite sides of one of said top panel and back cover, for capturing said coupling plate and thereby horizontally aligning said coupling plate with respect to at least one of said top panel and back cover.

31. The laundry dryer as claimed in claim 30, wherein said top panel has a rear surface disposed rearward of said back cover, creating a rear-surface offset between said top panel and said back cover, said coupling plate having a cross-section corresponding to a profile created by the rear-surface offset.

32. The laundry dryer as claimed in claim 31, wherein the pair opposing stops are formed on the rear surface of said top panel.

33. A laundry dryer comprising:
a top panel forming a top face of an outer case;
a back cover forming a rear face of the outer case;
a coupling plate having a main support for reinforcing a structural strength of the outer case, said coupling plate having a first mounting flange coupled with said top panel and a second mounting flange coupled with said back cover, the first and second mounting flanges integrally formed with opposite edges of the main support; and
self-alignment means including at least one alignment finger provided to said coupling plate to oppose at least one finger hole, the finger holes being correspondingly formed in said top panel to receive said at least one alignment finger and thereby horizontally align said coupling plate with respect to at least one of said top panel and back cover.

34. The laundry dryer as claimed in claim 33, wherein said top panel has a rear surface disposed rearward of said back cover, creating a rear-surface offset between said top panel and said back cover, said coupling plate having a cross-section corresponding to a profile created by the rear-surface offset.

35. The laundry dryer as claimed in claim 34, wherein the finger holes corresponding to the at least one alignment finger are formed in the rear surface of said top panel.

36. A method for manufacturing a home appliance assembly including an outer case comprising at least two panels forming adjacent faces of an outer case and a coupling plate for reinforcing a structural strength of the outer case, the method comprising:
joining the coupling plate with a first panel of the at least two adjacent panels, to form a subassembly having an exterior surface, the subassembly being separately processed from a second panel of the at least two adjacent panels;
applying an enamel coating to the exterior surface of the subassembly; and
coupling the enamel-coated subassembly to the second panel.

37. The method as claimed in claim 36, wherein the enamel coating excludes the second panel.

38. The method as claimed in claim 36, wherein the outer case further comprises self-alignment means for aligning the coupling plate with respect to at least one of the first and second panels.

39. The method as claimed in claim 38, wherein the coupling plate is vertically aligned with respect to at least one of the at least two adjacent panels by abutting the main support against a horizontal surface created by offsetting rear surfaces of the first and second panels.

40. The method as claimed in claim 38, wherein the coupling plate is horizontally aligned with respect to at least one of the at least two adjacent panels by capturing the coupling plate between a pair of opposing stops respectively provided to opposite sides of at least one of the at least two adjacent panels.

41. The method as claimed in claim 38, wherein the coupling plate is horizontally aligned with respect to at least one of the at least two adjacent panels by firmly engaging at least one alignment finger with opposingly provided finger holes correspondingly formed in at least one of the two adjacent panels to receive the at least one alignment finger.

42. The method as claimed in claim 36, wherein the first panel is a top panel forming a top face of the outer case and the second panel is a back cover forming a rear face of the outer case.

43. The method as claimed in claim 36, wherein the home appliance assembly is a laundry dryer.

44. The method as claimed in claim 36, wherein the coupling plate is joined with the first panel by at least one selected from the group consisting of a spot weld, rivet, and Tox round joint.

45. The method as claimed in claim 36, wherein the coupling plate is joined with the first panel by a threaded coupling means.
